(19) United States
(12) Patent Application Publication
(10) Pub. No.: US 2021/0229004 A1
(43) Pub. Date: Jul. 29, 2021

(54) TUBULAR FILTER WITH NONWOVEN MEDIA AND METHOD

(71) Applicant: Jonell Filtration Products, Inc., Breckenridge, TX (US)

(72) Inventors: Donald Cho, Carrollton, TX (US); Alan Lee Clarke, Mineral Wells, TX (US); Dwayne Austin Weddle, Graham, TX (US)

(21) Appl. No.: 17/154,487

(22) Filed: Jan. 21, 2021

Related U.S. Application Data
(60) Provisional application No. 62/964,914, filed on Jan. 23, 2020.

(51) Int. Cl. B01D 29/00; B01D 29/11

(52) U.S. Cl. CPC B01D 29/0022; B01D 2239/0668; B01D 2239/0618; B01D 29/111

(57) ABSTRACT

A filter element is provided that includes a plurality of individual fibers, wherein each individual fiber has a non-circular cross-section. The filter element also includes at least one flat sheet media, wherein the plurality of individual fibers are thermally bound to the at least one flat sheet media, wherein the flat sheet media is spirally wound to create a cylindrical profile.

### RELATED APPLICATIONS AND INCORPORATION BY REFERENCE

This application claims benefit of and priority to U.S. provisional patent application Ser. No. 62/964,914 filed Jan. 23, 2020. The foregoing application, and all documents cited therein or during its prosecution (“appln cited documents”) and all documents cited or referenced in the appln cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### FIELD OF THE DISCLOSURE

The present disclosure generally relates to filtration media technology for use in various industrial applications.

### BACKGROUND OF THE INVENTION

Filtration media technology is widely used in a variety of industrial applications, including, but not limited to the oil and gas industries. Filters are generally elongated in shape with an entrance end and an exit end. A gas or liquid flows through the filter and various contaminants such as dirt are captured by various media within the filter housing and therefore removed from the gas or liquid stream.

While the shape and basic function of filters is fairly consistent across various filter types, the media that actually filters the gas or liquid flow varies widely. These variations can include materials, manufacturing processes, and arrangement of the media.

There continues to be a need for improvement in filtration performance (e.g. the amount of contaminants collected and flow rate) as well as a need for improved strength and rigidity of the elongated filters themselves.

### BRIEF SUMMARY OF THE INVENTION

In one aspect of the present disclosure, a filter element is provided. The filter element comprises a plurality of individual fibers, wherein each individual fiber comprises a lobal cross-section, wherein the lobal cross-section comprises a plurality of lobes extending from a central portion. The filter element further comprises at least one flat sheet media, wherein the plurality of individual fibers are thermally bound to the at least one flat sheet media, wherein the flat sheet media is spirally wound to create a cylindrical profile.

In another aspect of the present disclosure, a method of manufacturing a filter is provided. The method includes providing a plurality of individual filtration fibers and a flat sheet media and winding the flat sheet media into a spiral shape. The method further includes binding the plurality of individual filtration fibers to the flat sheet media using heat during the step of winding the flat sheet media.

### BRIEF DESCRIPTION OF THE DRAWINGS

The disclosure will be more readily understood in view of the following description when accompanied by the below figures and wherein like reference numerals represent the elements, wherein:

FIG. 1 is an image of a filter element.

FIG. 2A is a cross-sectional image of one embodiment of filter media fibers.

FIG. 2B is a cross-sectional image of another embodiment of filter media fibers.

FIG. 2C is a cross-sectional image of another embodiment of filter media fibers.

FIG. 3A is an image of a plurality of filter media fibers that are not thermally bonded together.

FIG. 3B is an image of a plurality of filter media fibers that are thermally bonded together.

FIG. 4 is an embodiment of a filter element with multiple layers.

### DETAILED DESCRIPTION OF THE INVENTION

The following disclosure as a whole may be best understood by reference to the provided detailed description when read in conjunction with the accompanying drawings, drawing description, abstract, background, field of the disclosure, and associated headings. Identical reference numerals when found on different figures identify the same elements or a functionally equivalent element. The elements listed in the abstract are not referenced but nevertheless refer by association to the elements of the detailed description and associated disclosure.

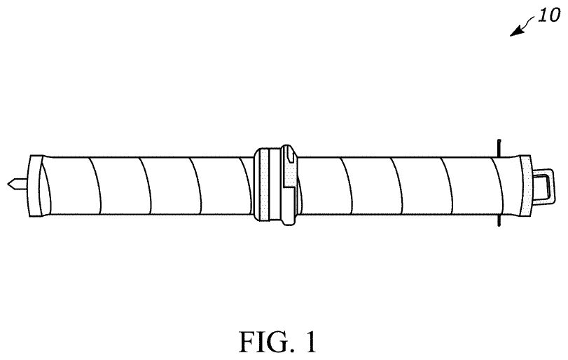

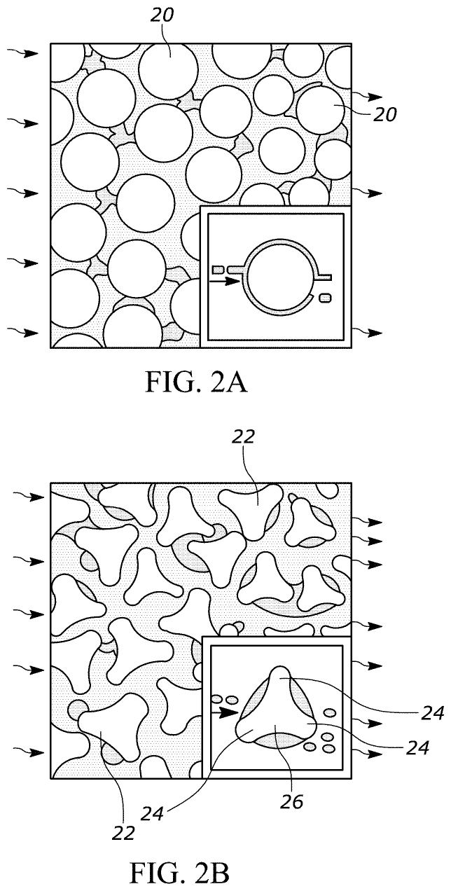

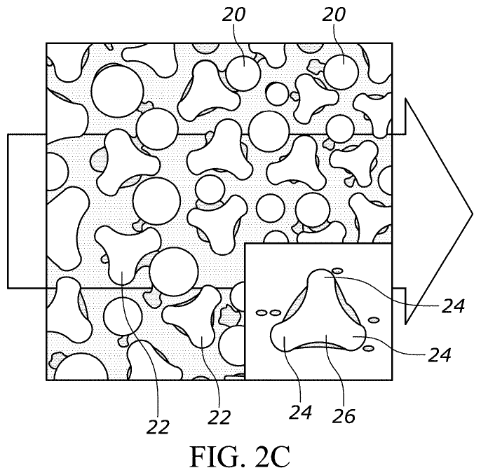

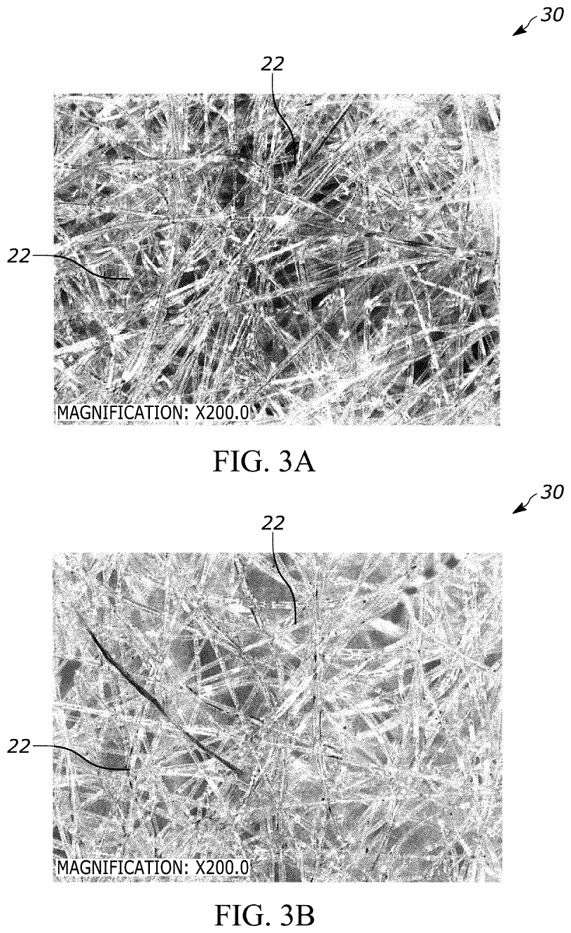

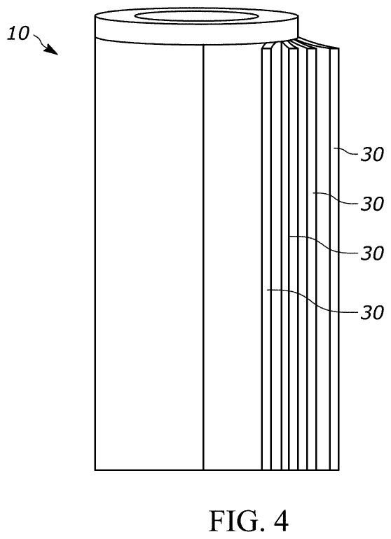

FIG. 1 shows an elongated filter element 10. The elongated filter element 10 may include multiple layers of non-woven filtration media 30 (shown, for example, in FIG. 4) made up of individual fibers 20 (in FIG. 2A) or 22 (in FIG. 2B), or a combination of both fibers 20, 22 (in FIG. 2C). FIGS. 3A and 3B show one such layer 30 of non-woven filtration media made up of a plurality of individual fibers 22. FIG. 3A show the plurality of individual fibers 22 prior to the fibers 22 being bonded together while FIG. 3B shows the plurality of individual fibers 22 after the fibers 22 are bonded together. The fibers can be bonded together in a variety of ways, including but not limited to thermal bonding, mechanical interlock, adhesives, resins, solvents and chemical bonding agents. The non-woven filtration media is designed to attract and capture contaminants in a gas or liquid stream. For example, in a gas stream, the non-woven filtration media may be designed to attract and capture liquid and solid contaminants in the gas stream as the gas stream passes from left to right on FIGS. 2A, 2B, and 2C. While the elongated filter element 10 has a generally cylindrical shape, the disclosure is not so limited as other shapes may be used.

The cross-sectional profile of each individual fiber is traditionally circular such as shown in FIG. 2A at reference number 20. However, the novel design of the fibers 22 shown in FIG. 2B uses a non-circular cross-section to improve contaminant holding and coalescing performance. In FIG. 2C, the filter element 10 utilizes a combination of the fibers 20 with circular cross-sections and fibers 22 with non-circular cross-sections. In this embodiment, the fibers 22 have a tri-lobal cross-section where three lobes 24 extend from a central portion 26 of the fiber 22. The lobes 24 may all be uniform in size, shape, and orientation, or the lobes may be irregular in size, shape, and orientation. In addition, The fibers 22 can have a variety of regular and irregular cross-sections. While one embodiment utilizes a tri-lobal cross-section 22, any number of lobes can be used, including four or more lobes, as desired. Further, while this particular embodiment utilizes a lobal cross-section any type of irregular cross-section for the fibers 22 may advantageously increase the overall efficacy of the filter element 10.

The tri-lobal cross-section 22 has significant advantages. For example, the tri-lobal cross-section 22 enables a more open structure that increases void spaces between each fiber 22 to allow for capture of contaminants in liquid or solid form as well as increased pathways for gas flow throughout. These advantages may lead to improved contaminant holding, removal efficiency, coalescing performance, and airflow through the filter element 10.

The filter element 10 may be manufactured in a variety of ways known in the art and with reference to FIG. 4 of, and as further described in, U.S. Pat. No. 5,893,956, which is incorporated by reference herein. Typically, the filter element 10 is composed of multiple layers 30 of non-woven filtration media (such as shown in FIGS. 3A and 3B) with each layer containing a plurality of fibers 20 or 22 that are bonded together and then arranged in a spirally wound manner, such as shown in FIG. 4. The layers 30 can be bonded together in a variety of ways, including but not limited to adhesives, resin, chemical bonding agents, sintering, lamination, or other similar methods. While in this embodiment, the layers 30 are composed of non-woven filtration media, they may also be made of other materials, including but not limited to woven mesh and membrane materials.

In the prior art, the individual fibers 20, 22 are thermally bonded together on a flat sheet media. After the individual fibers are thermally bonded, the flat sheet is mechanically wound into a spiral shape to form a cylindrical profile by using the machine depicted in FIG. 4 of U.S. Pat. No. 5,893,956, which results in a profile similar to the filter element 10 shown in FIG. 1. Multiple flat sheets, each with their own set of individual fibers, may be layered together to create a filter element 10. This standard manufacturing process, and in particular the mechanical winding of the flat sheet media, imparts un wanted stress and strain on the thermally bound fibers as the fibers naturally want to revert back to their original, unwound state. This unwanted stress decreases the durability and rigidity of the final filter element 10.

To reduce or eliminate the unwanted stresses described above, the present embodiment may be manufactured in an alternative manner. Specifically, the present embodiment thermally binds the individual fibers 20, 22 together during the winding process, thereby forming the final, desired cylindrical shape without imparting unwanted mechanical stress on the thermal bounds between the fibers.

The above detailed description and the examples described therein have been presented for the purposes of illustration and description only and not by limitation. It is therefore contemplated that the present disclosure cover any and all modifications, variations or equivalents that fall within the spirit and scope of the basic underlying principles disclosed above and claimed herein.

1. A filter element, comprising:
at least one layer comprising a plurality of individual fibers, wherein at least a subset of the plurality of individual fibers each comprises a non-circular cross-section; and at least one flat sheet media, wherein the flat sheet media is configured as spirally wound having a cylindrical profile, such that the plurality of individual fibers are bound to the at least one flat sheet media when configured with the cylindrical profile.

2. The filter element of claim 1, wherein the non-circular cross-section comprises a plurality of lobes extending from a central portion.

3. The filter element of claim 1, wherein the plurality of lobes are three lobes.

4. The filter element of claim 1, wherein the plurality of individual fibers are thermally bound to the at least one flat sheet media.

5. The filter element of claim 1, wherein the plurality of individual fibers are mechanically interlocked to the at least one flat sheet media.

6. The filter element of claim 1, wherein the cylindrical profile of the flat sheet media comprises a cross-section through which a stream of gas or liquid is configured to pass through, wherein the plurality of individual fibers are configured to attract and capture liquid and solid contaminants in the stream as the stream passes through the cross-section.

7. The filter element of claim 1, wherein the at least one layer comprises a plurality of layers attached to one another.

8. The filter element of claim 7, wherein each of the cylindrical profiles of the flat sheet media in each of the plurality of layers comprises a cross-section through which a stream of gas or liquid is configured to pass through, wherein the plurality of individual fibers are configured to attract and capture liquid and solid contaminants in the stream as the stream passes through each of the cross-sections.

9. The filter element of claim 8, wherein the non-circular cross-section comprises a plurality of lobes extending from a central portion.

10. The filter element of claim 1, wherein the at least a subset of the plurality of individual fibers is a first subset of the plurality of individual fibers, wherein at least a second subset of the plurality of fibers comprises a substantially circular cross-section.

11. A method of manufacturing a filter, comprising:
providing a plurality of individual filtration fibers and a flat sheet media, wherein at least a subset of the plurality of individual fibers each comprises a non-circular cross-section;
winding the flat sheet media into a spiral shape; and
binding the plurality of individual filtration fibers to the flat sheet media during the step of winding the flat sheet media.

12. The method of claim 11, wherein the non-circular cross-section comprises a plurality of lobes extending from a central portion.

13. The method of claim 12, wherein the plurality of lobes are three lobes.

14. The method of claim 13, further comprising forming a plurality of flat sheet media by repeating the steps of providing, winding, and binding, wherein each of the plurality of flat sheet media comprises its own individual plurality of fibers.

15. The method of claim 11, further comprising forming a plurality of flat sheet media by repeating the steps of providing, winding, and binding, wherein each of the plurality of flat sheet media comprises its own individual plurality of fibers.

16. The method of claim 11, wherein the step of binding the plurality of individual filtration fibers further comprises using heat to bind the plurality of individual filtration fibers to the flat sheet media.

17. The method of claim 11, wherein the at least a subset of the plurality of individual fibers is a first subset of the plurality of individual fibers, wherein at least a second subset of the plurality of fibers comprises a substantially circular cross-section.
